(19) United States
(12) Patent Application Publication
(10) Pub. No.: US 2025/0267074 A1
(43) Pub. Date: Aug. 21, 2025

(54) SYSTEMS AND METHODS FOR FACILITATING IDENTIFICATION AND DELIVERY OF MACHINE LEARNING MODELS IN WIRELESS COMMUNICATION NETWORKS

(71) Applicant: AT&T Intellectual Property I, L.P., Atlanta, GA (US)

(72) Inventors: Isfar Tariq, Austin, TX (US); Salam Akoum, Austin, TX (US); Thomas Novlan, Jonestown, TX (US)

(73) Assignee: AT&T Intellectual Property I, L.P., Atlanta, GA (US)

(21) Appl. No.: 18/443,551

(22) Filed: Feb. 16, 2024

(51) Int. Cl. H04L 41/16; H04W 24/02

(52) U.S. Cl. CPC H04L 41/16; H04W 24/02

(57) ABSTRACT

Aspects of the subject disclosure may be directed to, for example, a method including determining one or more hierarchical levels associated with one or more machine learning (ML) models deployed in wireless communication networks, and generating one or more identifications (IDs) of the one or more ML models based on the one or more hierarchical levels. The one or more IDs of the one or more ML models indicate a network function associated with the one or more IDs, a ML model structure, a ML model delivery format, or a combination thereof. Other embodiments are disclosed.

### FIELD OF THE DISCLOSURE

The subject disclosure relates to systems and methods for facilitating identification and delivery of machine learning models in wireless communication networks.

### BACKGROUND

Air interfaces operating in wireless communication networks can be augmented with features enabling improved support of artificial intelligence and/or machine learning based algorithms. The augmented air-interfaces may facilitate enhanced performance and reducing complexity or overhead of wireless communication networks including and not limited to 5G network systems. The enhanced performance due to the artificial intelligence and/or machine learning based algorithms depends on use cases and can be related to improved throughput, robustness, accuracy, reliability, etc.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a network environment that facilitate a first collaboration level.

FIG. 2C is a block diagram illustrating an example, non-limiting embodiment of a network environment that facilitate a second collaboration level.

FIG. 2D is a block diagram illustrating an example, non-limiting embodiment of a network environment that facilitate a third collaboration level.

FIG. 2E is a block diagram illustrating an example, non-limiting embodiment of a hierarchical categorization of identification of ML models network environment that facilitate a first collaboration level.

FIG. 2F is a block diagram illustrating an example, non-limiting embodiment of relationships between one or more functionalities and one or more ML models in different use cases.

FIG. 2G depicts an illustrative embodiment of a functionality ID structure.

FIG. 2H depicts an illustrative embodiment of a model ID structure.

FIG. 2I depicts an illustrative embodiment of a method in accordance with various aspects described herein.

FIG. 2J depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for generating an identification (ID) of an artificial intelligence (AI) or a machine learning (ML) model (hereinafter, collectively referred to as a ML model) deployed in wireless communication networks. The generated ID of the ML model is used to identify a corresponding lifecycle management of the ML model and support a wide range of different ML models and use cases. Other embodiments are described in the subject disclosure.

One or more aspects of the subject disclosure are directed to a method which includes determining, by a processing system including a processor, one or more hierarchical levels associated with one or more machine learning (ML) models deployed in wireless communication networks and generating one or more identifications (IDs) of the one or more ML models based on the one or more hierarchical levels. The one or more IDs of the one or more ML models indicate one or more network functions associated with the one or more IDs, a ML model structure, a ML model delivery format, or a combination thereof.

One or more aspects of the subject disclosure are directed to a non-transitory machine-readable medium, comprising executable instructions that, when executed by a processing system including a processor, facilitate performance of operations. The operations include determining a hierarchical level of a machine learning (ML) model deployed in wireless communication networks including a radio access network (RAN), and based on the determined hierarchical level, generating an identification (ID) of the ML model, wherein the ID of the ML model indicates one or more network functions associated with the ID of the ML model, a ML model structure, a ML model delivery format, or a combination thereof. The ID of the ML model is globally unique within the wireless communication networks.

One or more aspects of the subject disclosure are directed to a device, including a processing system including a processor, and a memory that stores executable instructions that, when executed by the processing system, facilitate performance of operations. The operations include determining one or more hierarchical levels associated with one or more machine learning (ML) models deployed in wireless communication networks, and, based on the one or more hierarchical levels, generating the one or more identifications (IDs) of the one or more ML models, wherein each of the one or more IDs comprise a plurality of sub-IDs contained in a plurality of data fields.

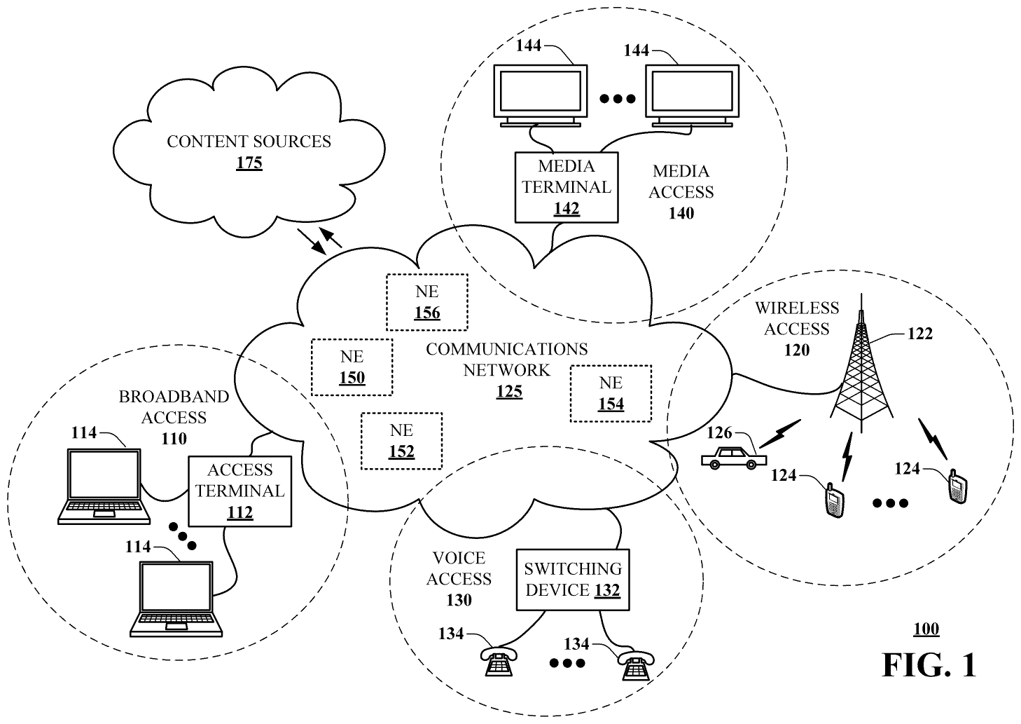

Referring now to FIG. 1, a block diagram is shown illustrating an example, non-limiting embodiment of a system 100 in accordance with various aspects described herein. For example, system 100 can facilitate in whole or in part generating an identification (ID) of a machine learning (ML) model deployed in wireless communication networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

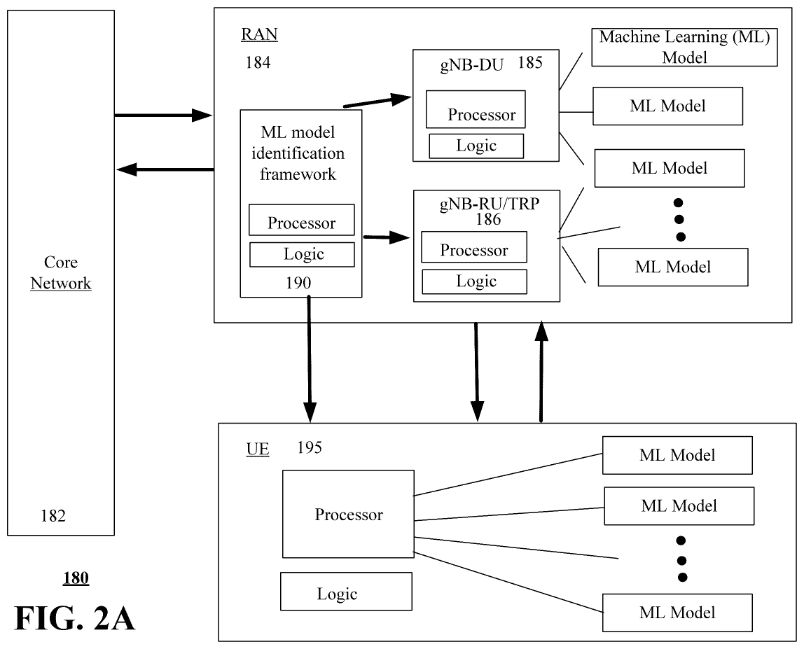

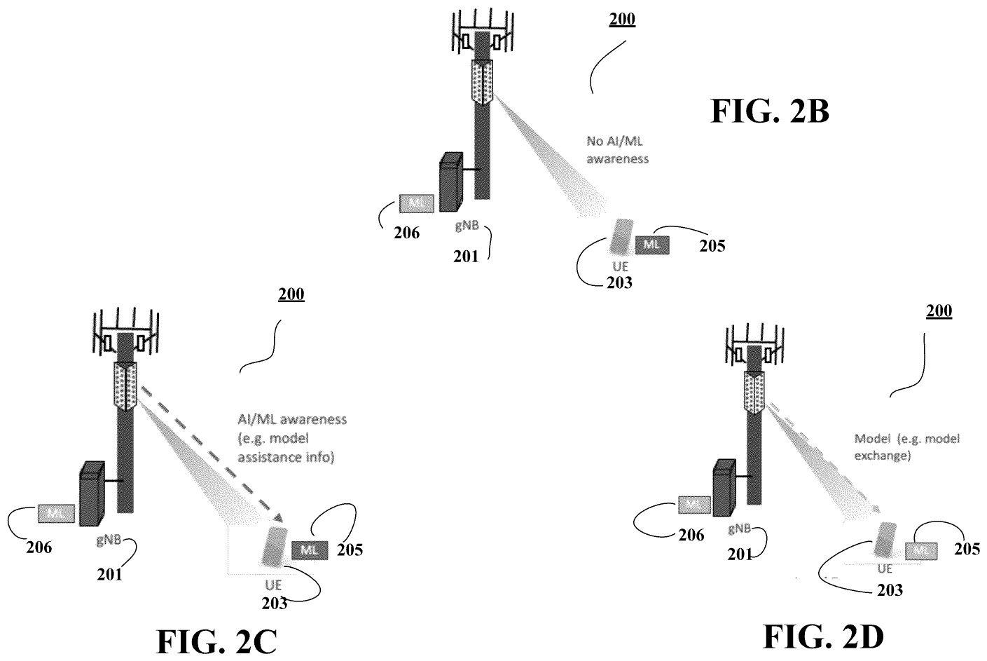

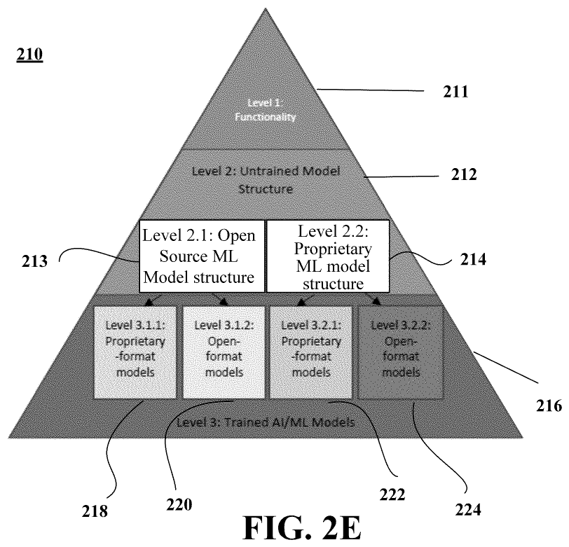

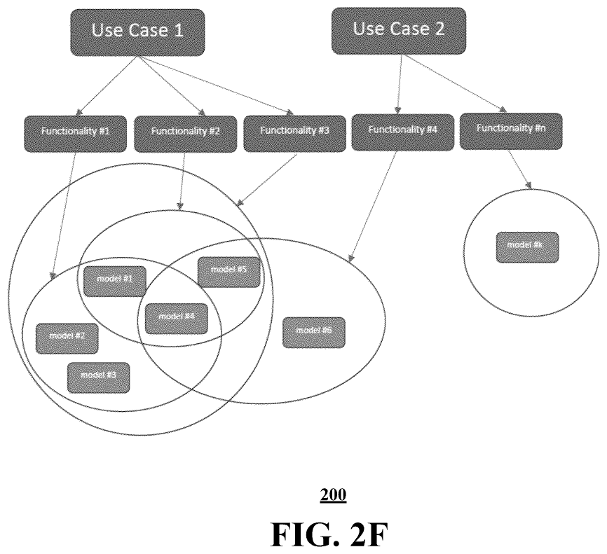

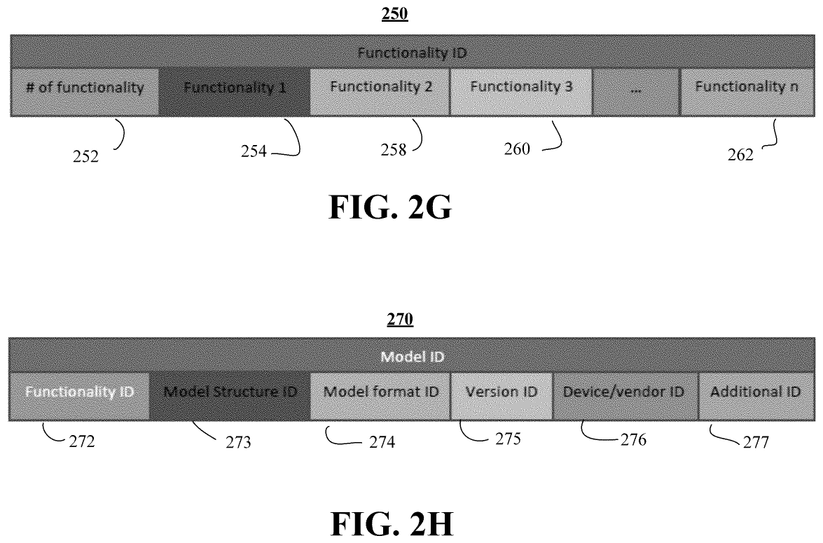

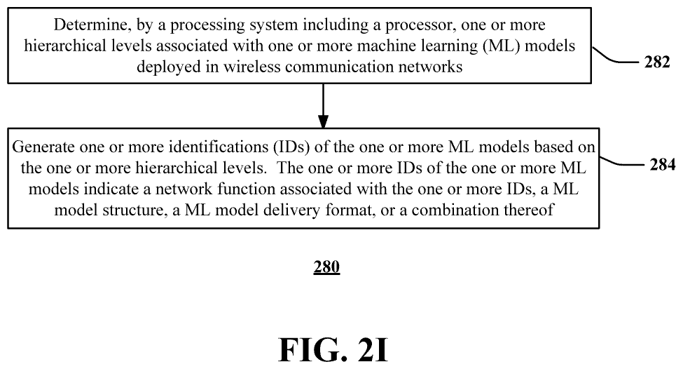

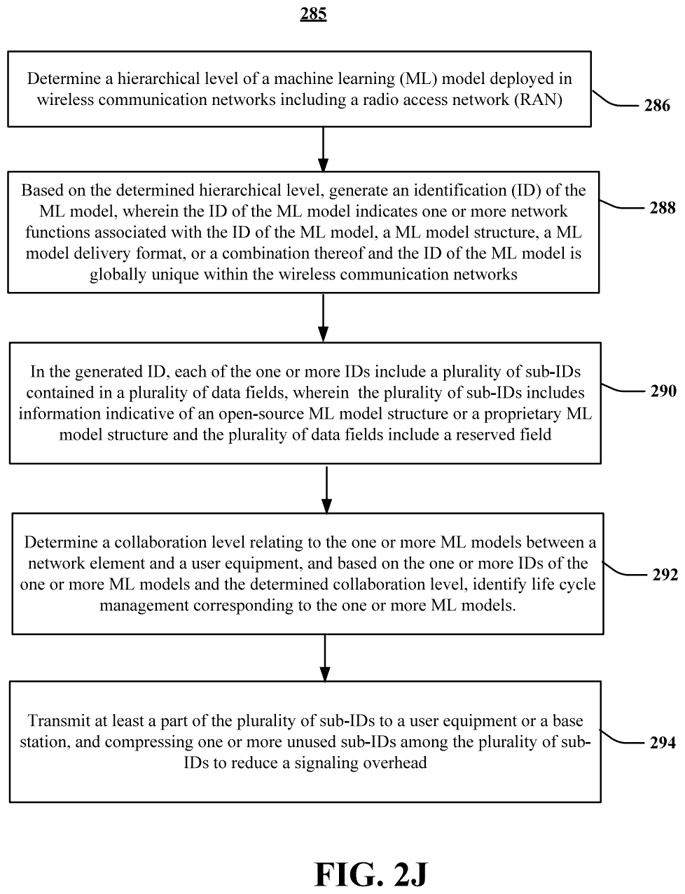

FIG. 2A is a block diagram illustrating an example, non-limiting embodiment of a system functioning within the communication network of FIG. 1 in accordance with various aspects described herein. The system 180 includes a core network 182, a radio access network (RAN) 184, and a user equipment 195. The RAN 184 is in communication with the core network 182 and the UE 195. Various machine learning (ML) models are deployed in the RAN 184, the UE 195 or both. In other words, between the RAN 184 and the UE 195, a deployment of the ML models can be one-sided or two-sided. In some embodiments, the RAN 184 is implemented as Open RAN and includes a distributed unit of a gNodeB (gNB-DU) 185 and a radio unit of the gNodeB (gNB-RU) or a transmission receiving point 186. As depicted in FIG. 2A, the RAN 184 includes a ML model identification framework 190 having a processor and a logic, which relates to managing various and different ML models deployed in the system 180. In some embodiments, the gNB-DU 185, the gNB-RU/TRP 186, and the UE 195 include a processor and a logic which can manage and handle different ML models deployed in the system 180 and their LCM procedures in coordination with the ML model identification framework 190. In some embodiments, the ML model identification framework 190 may reside in the core network 182 or be distributed over the wireless communication networks.

The terminology and lifecycle management (LCM) procedures for augmenting air interfaces with technical features enabling improved support of ML based algorithms are in the process of being defined in the Third Generation Partnership Project (3GPP). Depending on where ML models reside, and a collaboration level between the network including a base station and a user equipment (UE), there is a need for a flexible, streamlined procedure on how to identify a model or a family of models used at the user equipment (UE) and/or the network. It is desirable that this procedure will be future proof for all ML features and use cases to improve the performance of 5G networks and further next generation wireless communication networks. The identification procedure of ML models is crucial for performance monitoring and finetuning of ML models associated with network function(s).

The identification of ML models should be efficient on how a model identification is indicated via signaling or facilitating a faster activation/deactivation of a given model for a certain network function, thereby avoiding a network performance degradation. There is no current standard or common framework and therefore, a common framework for designing an ML model identification (ID) and LCM procedures, which applies to current ML use cases in 5G networks and future networks, is desirable. It is also desirable that the common framework for designing the ML model ID and LCM can be easily expanded to any future use cases. Available solutions are generally directed to designing a different framework for different hierarchical levels/categories of the ML models (e.g., trained models v. untrained models). Such solutions may not be scalable in particularly for future use cases. However, the common framework described in the present disclosure is directed to designing a hierarchical system for a ML model ID and LCM procedures such that not only current use cases and network functionalities but also future use cases and network functionalities can be supported.

In the present disclosure, an ML model may be defined as a data driven algorithm by applying machine learning techniques that generates a set of desired outputs based on a set of inputs. In various embodiments, the ML model may be implemented with a deep neural network, a classical model such as regression, support vector machine (SVM), decision trees, or any other data driven algorithm.

In various embodiments, different types of ML models may be considered depending on where the ML models reside, i.e., where an inference by the ML model occurs. As one example, a one-sided model at the UE indicates that an ML model performs an inference at the UE. As another example, a one-sided model at the network such as a base station or a mobile core in some instances indicates that an ML model performs inference at the network. As further another example, a two-sided model indicates that a paired ML model(s) over which a joint inference is performed, where the joint inference is performed jointly across the UE and the network. A first part of inference is performed by UE and then a remaining part is performed by a gNB, or vice versa.

In various embodiments, life cycles of the ML models involve various stages, for example, from a data collection, a data transfer, an algorithm selection, a model transfer, to a model building, training, tuning, testing, deployment, management, monitoring, and inference.

In various embodiments, the ML model training includes a process to train an ML model by learning input and output relationships in a data driven manner and obtain a trained ML Model for inference.

In various embodiments, the ML model transfer includes delivery of an ML model over an air interface, either parameters of a model structure known at a receiving end or a new model with parameters. Delivery may contain a full model or a partial model.

In various embodiments, a model activation includes enabling an ML model for a specific network function. A model deactivation includes disabling an ML model for a specific network function. A model switching includes deactivating a currently active ML model and activating a different ML model for a specific network function. A model update includes a process of updating model parameters and/or a model structure of an ML model. A model parameter update includes a process of updating model parameters of an ML model.

In various embodiments, one-sided ML models reside at the UE or at the network, and one or multiple ML models can be possibly deployed and used at the UE or at the network. For two-sided ML models, multiple ML models can be possibly deployed. It is important to monitor performance of these ML models for various reasons: (1) depending on a type of ML model used, there may be no performance guarantees, (2) deployment options and environment characteristics may change after deployment, resulting in a sub-optional performance, (3) when multiple ML models are available at the UE, at the network or both, a ML model selection decision needs to be made, and this decision cannot be left to implementation, (4) for one-sided models at UE, the ML model or input/output parameters of ML models may be modified over time, from a third party cloud, without notifying the network, resulting in a performance degradation.

In some embodiments, for the UE, the network or both to be able to make certain decisions, based on the model performance monitoring or otherwise, a model identification and LCM procedure may need to be agreed on. This identification procedure may be flexible so it can cover all diverse types of models, where the model inference resides, and support all collaboration levels between the network and the UE. The model identification procedure will also indicate the functionalities applicable to the different ML use cases in various conditions and/or scenarios.

FIGS. 2B through 2D depict illustrative embodiments of one or more ML models deployed in wireless communication networks. The wireless communication networks 200 include a base station (gNB) 201 and a user equipment 203 by way of example. FIGS. 2B through 2D illustrate one base station 201 and one user equipment 203 for convenience of description, but the present disclosure is not limited thereto. As depicted in FIGS. 2B through 2D, one or more ML models 205, 206 are deployed in the wireless communication networks 200. The wireless communication networks 200 include air interfaces that can be augmented by enabling support for the one or more ML models 205, 206.

FIGS. 2B through 2D depict different collaboration levels relating to the ML models 205, 206 between the base station 201 and the user equipment 203. In various embodiments, ML collaboration levels can be defined between the UE and the network as follows:
Collaboration level x, where no collaboration is assumed between the network and the UE;
Collaboration level y, where the collaboration is signaling based with no ML model transfer; and
Collaboration level z, where the collaboration is signaling based with ML model transfer.

FIG. 2B is a block diagram illustrating an example, non-limiting embodiment of a network environment that facilitates the collaboration level x. The collaboration level x corresponds to an implementation-based ML operation without any dedicated ML specific enhancements (e.g., LCM signaling, reference signals enhancements). FIG. 2C is a block diagram illustrating an example, non-limiting embodiment of a network environment that facilitate the collaboration level y. FIG. 2D is a block diagram illustrating an example, non-limiting embodiment of a network environment that facilitate the collaboration level z. In some embodiments, the boundary between the collaboration levels y and z is based on whether a model delivery is transparent to 3GPP signaling over the air interface or not, as will be described in detail below.

In various embodiments, a process of identifying an ML model at the UE or the network (e.g., a base station) is important for performance monitoring and inference, irrespective of the collaboration levels as depicted in FIGS. 2B through 2D. These different collaboration levels will result in different levels of detail regarding an ML model to be known at both sides and available LCM procedures. For instance, for collaboration level x, the model ID 205 may not be signaled to the network and a performance monitoring of various models within the UE 203 may be done by the UE 203 running the inference, or a third-party server. Additionally, or alternatively, the network (e.g., the ML model identification framework 190, the core network 182, the gNB-DU 185, or the gNB-RU/TRP 186, etc.) may explicitly monitor the model performance for the collaboration level z environment, activate or deactivate the ML model, etc.

In various embodiments, there are different levels of information that may be known about ML models. Generally, an ML model can be categorized as either having a proprietary ML model structure or open-source ML model structure. For the proprietary ML model structure, an ML model uses an ML algorithm and/or input/outputs that are proprietary, which may not be a part of the 3GPP standards. For the open-source ML model structure, an ML model uses an ML algorithm and input/outputs that are mutually recognizable across vendors of wireless communication networks and can allow interoperability, which may be a part of the 3GPP standards.

In various embodiments, information as to a particular ML model structure enables a UE device to report over-the-air if the UE can support that particular ML model or not. Additionally, different ML model structures will also result in different LCM procedures. As one example, for an open-source ML model, a model update or transfer, may be directed to transmission of new or updated weights or parameters of the open-source ML model as the structure may be already known. On the other hand, for a proprietary model format, the model transfer or update may result in compiling and transmission of a complete ML model containing both the model structure and weights. Additionally or alternatively, in the event of common understanding present between the UE and the network regarding a proprietary model structure, even though it is still proprietary to any third party, the model transfer or update can be performed by transmitting the new and/or updated weights and/or parameters.

In various embodiments, an ML model format for delivery over-the-air interface may have different LCM procedures for proprietary-format model or open-format model. As one example, proprietary-format ML models include ML models of a vendor-specific format or a device-specific proprietary format, which may not be a part of or different from the 3GPP standards. As another example, the device-specific proprietary format includes a device-specific binary executable format. As further another example, the proprietary format models may include the ML model structure, input and/or output and weights and/or parameter, which are compiled into a single file that can be used directly for inference.

Open-format models include ML models of specified format that are mutually recognizable across vendors and allow interoperability, which may be a part of the 3GPP standards. In various embodiments, the open-format models may include the ML model structure, input and output, weights and parameters or a combination thereof, which are compressed through a known format across vendors. This model information, when compressed, will need to be decompressed and complied before the model information can be used for model update and inference.

In various embodiments, various factors, such as the collaboration levels, one-sided or two-sided ML models, etc. change an identification process of an ML model. To facilitate the identification process of the ML model, an identification (ID) of the ML model is generated and used which can support current use cases and functionalities. Due to these wide variety of options available regarding ML models, a model ID and the corresponding LCM procedures are designed and generated in a manner such that the model ID can support a wide variety of options for different use cases.

FIG. 2E is a block diagram illustrating an example, non-limiting embodiment of a hierarchical categorization of ML models in a wireless communication network environment for identifying the ML models. In various embodiments, different categories of the ML models can be divided into some example use cases for each category and a model ID and the LCM procedure can be designed in order to support different categories of the ML models. Then signaling corresponding model categories and in what granularity to make a decision based on several factors is described, including the features supported, deployment environment, a carrier frequency, a serving cell, performance monitoring results, etc.

As depicted in FIG. 2E, various ML models are categorized into different hierarchical levels 210. For instance, the different hierarchical levels 210 include Level 1 corresponding to functionality 211, Level 2 corresponding to an untrained model structure 212, and Level 3 corresponding to a trained model structure 216. The Level 2 includes an open source ML model structure 213 and a proprietary ML model structure 214. The Level 3 includes open source ML model formats 218, 224 and proprietary ML model formats 220, 222 which have either an open source ML model structure or a proprietary ML model structure.

In various embodiments, ML models can be directed to network functionalities (Level 1) 211. For instance, the ML models are used to provide functionalities such as channel state information (CSI) prediction used in the downlink direction in 5G New Radio networks, for the purpose of channel sounding and used to measure the characteristics of a radio channel, beam management, possible scenario/configurations (e.g., indoor/outdoor, rank, prediction time, a number of beams), performance requirements and/or input and output details (e.g., input/output numbers of bits). This detail is required for functionality-based LCM procedures which can include, for example, performance monitoring, functionality activation, deactivation or fallback ctc. FIG. 2F is a block diagram illustrating an example, non-limiting embodiment of relationship between one or more functionalities and one or more ML models in different use cases. Different use cases such as use case 1 and use case 2, may be related to different functionalities such as functionalities #1 through #5. Each functionality relates to one or more ML models #1 through #k.

In some embodiments, the functionalities of an ML model are implemented as one-sided, either at a base station or at the UE. In case of a UE sided ML model, the network may inform the UE of the desired functionality. Alternatively, in case of the network sided ML model, the UE may inform the network of the desired functionality. In some embodiments, there may be multiple ML models corresponding to a given functionality (e.g., shown in FIGS. 2A and 2F) and the UE and/or network can decide a specific ML algorithm to use for the functionality. The UE and/or the network can switch among these ML models for a given functionality. In other embodiments, the functionalities of an ML model can also be potentially implemented for two-sided models assuming that there is no model transfer, where the network or UE can inform the other entity of the desired functionality.

In various embodiments, possible functionalities are standardized into one or more functionality IDs which correspond to a standardized signaling (e.g., to/from a gNB control unit (a gNB-CU)) used for functionality-based LCM, as will be described in connection with FIG. 2G later. For instance, the functionality-based LCM includes a functionality activation, a deactivation or a fallback, functionality update or switching, performance monitoring etc. It should be noted that multiple ML functionalities can be defined for each sub-use case at each UE. Furthermore, a single ML model can likely support multiple functionalities for a given use-case; however a single functionality may be active at any given time. Additionally or alternatively, a single ML model can also correspond to multiple use cases in which the single ML model can potentially have as many active functionalities as the number of active use cases.

Referring back to FIG. 2E, Level 2 corresponds to the untrained model structure 212. In various embodiments, ML models include an ML algorithm available in the pertinent field, such as Convolutional Neural Network (CNN), Long Short-Term Memory (LSTM), etc. and the structure of ML models, such as a number of layers, a number of neurons in each layer, and input/outputs details (e.g., input/output number of bits), vary. Additionally, the input and output details of ML models can be provided if not provided in the functionality of ML models.

In various embodiments, Level 2 may involve a common understanding between the gNB and the UE regarding the UE capability. Referring back to FIGS. 2B through 2D, two-sided models using collaboration level z (shown in FIG. 2D) where both gNB and UE are running a part of ML model(s), may be used. In other embodiments, Level 2 can also be used for collaboration level z with one sided models at the UE to understand if the UE is able to run ML model(s) of this complexity. Additionally or alternatively, Level 2 may work with a limited level of control in collaboration level y (shown in FIG. 2C) where the network may use Level 2 to make the UE switch between models of lower/higher computational complexity. Therefore, a model structure ID may be used in order to determine the structure of ML models.

As depicted in FIG. 2E, the untrained model structure 212 at Level 2 can be further divided into two sub-levels as will be described below.

### Level 2.1: Open-Source ML Model Structure

Most common use of this level is when a ML model has an open source ML model structure 213 that can be inferred through a model structure ID. The model structure ID will provide a common understanding between the UE and gNB regarding device capability. In various embodiments, a majority of the commonly used ML model structures can be standardized into a model structure ID to be known amongst all device and network vendors for use.

### Level 2.2: Proprietary ML Model Structure

Even proprietary models 214 can be benefited to have a common understanding of the device capability between the UE and the gNB, typically for the collaboration level z. However, this understanding will likely be specific to a given UE device and a network device. Therefore, some reserved options can be used in the model structure ID for these proprietary model structures. The UE and the network can determine offline what these reserved options in the model structure ID correspond and then can transmit the model structure ID together with a UE (device/operator) ID and a network (device/operator) ID to have a common understanding between the UE and the network. The UE (device/operator) ID and the network (device/operator) ID are used to identify the UE and the network (device/operator). In some embodiments, while a reserved space in the model structure ID is defined in standards such as the 3GPP, different model structures and their corresponding model structure IDs will likely be determined independently for each UE and network (device/operator) pair. In case when the UE or network want to share no information to any party (including the network or the UE), the model structure ID can be set to a default null value.

### Level 3: Trained ML Model 216

ML models are trained using a given dataset that can be used for inference directly or after compilation for a single or multiple use cases. In various embodiments, a trained ML model for a given use case can support one or multiple functionalities.

In various embodiments, the trained ML model 216 will be labelled with a unique global model ID. The global model ID can be used to determine information such as a version number (of the model), a dataset ID, a time stamp, a source ID (e.g., a device, a network, a chipset, software, a service provider or a vendor), in addition to the functionality and the untrained model structure. Any time when a new ML model is generated or there is a model update (with the same model structure) using a new dataset for a given use case or functionality a new “time stamp” and/or a new “version number” and/or a new “dataset ID” are generated.

In some embodiments, for the collaboration level z (shown in FIG. 2D), the trained ML models 216 can be in either a proprietary format 218, 222 or an open format 220, 224 with both of them having slightly different LCM procedures. Furthermore, the LCM procedures will be different if the model structure is open source or proprietary. Accordingly, these models can be classified into 4 levels 218, 220, 222 and 204, i.e., an open source ML model structure having a proprietary format 218 or an open format 220 and a proprietary ML model structure having a proprietary format 222 or an open format 224 as set forth in detail below.

### Level 3.1.1: Proprietary-Format Delivery 218 of ML Models:

In various embodiments, for a known model structure of the trained ML models 216, it is likely to be more efficient to send a full model as an executable format or as a proprietary format. For the proprietary-format delivery 218, there can be a mutual understanding between the network and the UE, which can be used to decompress (if needed) and execute an ML algorithm. In some embodiments, it is possible to update the model by transmitting model parameters over the air. In other embodiments, any model update may require transmitting a new trained model in a proprietary format.

### Level 3.1.2: Open-Format Delivery 220 of ML Models:

In Level 3.1.2, both the model structure and the model delivery format are known to both the UE and the network. In this case, typically the model delivery may be directed to transmitting trained model parameters as the model structure is known (due to capability reporting). There can still be an option to support a full model transfer if and as needed.

In some embodiments, the trained ML models 216 can include a proprietary ML model structure which uses proprietary-format 222 or open-format 224.

### Level 3.2.1: Proprietary-Format Models:

These proprietary models 222 have both the model structure and the model delivery in proprietary format. Typically, the proprietary models 222 will be delivered in an executable file and for any model update, a complete model will be transmitted. However, in case there is an understanding between the network and UE regarding the proprietary format in which model is delivered and the proprietary ML model structure, the model update can be performed by transmitting only the model parameters (in proprietary format).

### Level 3.2.2: Open-Format Models:

These open-format models 224 have a proprietary ML model structure but are delivered as open format model. An example will be a standardized compression used to compress the proprietary model or its parameters. This may be used in the cases where the network and UE have a common understanding of the proprietary structure of the ML model.

FIG. 2G depicts an illustrative embodiment of a functionality ID structure. In various embodiments, functionality ID involves a process for identifying an ML functionality for the common understanding between the network and the UE. In some embodiments, the functionality ID may be a specific ID known to the network or can be a reference to a signaling configuration used to indicate a certain functionality.

FIG. 2H depicts an illustrative embodiment of a model ID structure. In various embodiments, a model ID involves a process of identifying an ML model for the common understanding between the network and the UE. As described above, there are a wide variety of different use cases and how the ML model identification and LCM procedures for those use cases can be implemented. Therefore, a hierarchical model ID is generated that can support different ML models and their corresponding LCM. The hierarchical model ID design is efficient to transmit a required part of the model ID for any LCM. Furthermore, the hierarchical design is flexible so that it can be easily configured to support any future use case and LCM requirements, thereby having forward compatibility.

In various embodiments, the model ID may be globally unique within the network for any new ML model to correctly identify the ML model. The model ID includes information indicative of a different use case, a different model structure, model parameters and/or different training datasets. The level of detail regarding the model will be different for the different use cases and application. For instance, for a one-sided model with the collaboration level y (shown in FIG. 2B), functionality-based LCM procedures may be needed, and the functionalities may be reported via a control plane signaling. To support any additional features or functionalities that are not standardized in the current functionality specifications, model ID based LCM procedures may be used to support such features or functionalities. This may include higher granularities of parameters or performance requirements or new parameter that are not in the current standard. While there will be a reserved space for these new features and functionalities, the functionality and features that are mapped to the space will be left to the UE vendors and network vendors.

In various embodiments, the ML model identification framework 190 as depicted in FIG. 2A communicates with different network elements such as the core network 182, the RAN 184 and the UE 195 and generates a framework of the model ID and the functionality ID as depicted in FIGS. 2G and 2H. The ML model identification framework 190 further identifies, monitors and checks performance of ML models based on their model IDs and manages LCM procedures of identified ML models directly, or in coordination with the network elements. The collaboration levels between the network elements and the ML model structures and the ML delivery format will be considered in executing the LCM procedures of the identified ML models.

In various embodiments, the following hierarchical functionality ID and model ID include the following data fields as shown in FIGS. 2F and 2G.
1. Functionality ID(s) 250:
   Primarily, the functionality IDs indicate a number of supported functionalities 252 and individual functionality IDs 254, 258, 260 and 262. The individual functionalities can be modified one at the time or multiple (in case a ML model supports multiple use cases) using the functionality ID. The functionality ID 250 may be transmitted between UE and the network using control signaling. Additionally, or alternatively, as depicted in FIG. 2H, the functionality ID 272 can be included in the model ID 270.
2. Model structure ID 273:
   The model structure ID 273 identifies the structure of an ML model. The model structure ID 273 is used for capability reporting of the UE for model training or model transfer. This ID will be used for a standardized open source ML model structure. In some embodiments, there may be some reserved ID(s) to denote if a proprietary ML model structure is used.
3. Model Format ID 274:
   The model format ID 274 identifies the format in which the ML model can be delivered. In some embodiments, the model formal ID 274 may be used for model delivery and model update. Similar to model structure ID 273, the model format ID 274 can have both a standardized ID for an open format ML model and/or a reserved ID for a proprietary format model.
4. Version ID 275:
   The version ID 275 provides a current version ID for a current model. In some embodiments, the version ID 275 can contain information such as a data set ID or a time stamp etc. The version ID 275 may be updated every time a new model is generated or there is a model update. The version ID 275 can also be used as a pairing ID for the two-sided models.
5. Vendor source ID 276:
   The vendor source ID 276 provides an ID for a source of a model which may correspond to a device/UE, a chipset, a software/service provider or a network vendor. The vendor source ID 276 may be used to determine the function of reserved bits (e.g., the function of reserved bits can be decided offline among UE operators and network operators).
6. Additional information 277: Additional granularities.
   There can be some reserved bits to allow some additional information about the model. Some of it can be standardized in the 3GPP. The reserved bits can contain some ID not specified above. In addition, it can also contain some functionalities not supported in the current specification such as additional granularities or timing frequencies.

As described above, in some embodiments, the hierarchical model ID may include nested sub-IDs, instead of concatenated sub-IDs. In other embodiments, the model and functionality IDs may include hashed (e.g., look-up table) sub-IDs. As described in the above embodiments, the model ID can be unique for different models. Additionally, certain parts of the model ID, instead of the entirety of the model ID, may need to be transmitted for any required LCM. Furthermore, even for the functionality-based LCM procedures, there may be a model ID which is not shared with the other network entities. The hierarchy described above and depicted in FIG. 2E allows an operator or software/service provider to design simple testing and calibration mechanism to have test and calibration benchmarks based on the different functionalities, model structures and a delivery mechanism, instead of all possible model IDs.

In some embodiments, if one or more sub-IDs of a given model ID or functionality ID are unused or are comprised of common values across multiple models/functionalities or families of models/functionalities, compression of the entire ID or sub-IDs may be utilized to reduce signaling overhead. In other embodiments, the compression algorithm for the model ID or functionality ID may be fixed, standardized or may be indicated by the UE or the network as part of the model delivery and update LCM processes.

In some embodiments, a group of models and functionalities or a family of models and functionalities can correspond to a given chipset, network and service providers or vendors. In other embodiments, the indication of the ID will be for a given vendor, broadcasted to the corresponding UEs, or indicated to the corresponding network as part of the model update.

In some embodiments, when the model ID or the functionality ID or one or more sub-IDs of are transmitted over-the-air or sent over a wired transport network, the ID may be fully or partially scrambled or encrypted. In other embodiments, the scrambling/encryption of the ID may be based upon a security key derived directly from the ID or sub-IDs. In further another embodiment, the encryption may be based upon independent security keys or IDs from the model ID or functionality ID which are associated with the air interface (e.g., a UE identity or higher layer security key) or a transport layer (e.g., IPSEC).

FIG. 2I depicts an illustrative embodiment of a method in accordance with various aspects described herein. The method 280 includes determining one or more hierarchical levels associated with one or more machine learning (ML) models deployed in wireless communication networks (Step 282), and generating one or more identifications (IDs) of the one or more ML models based on the one or more hierarchical levels (Step 284). In various embodiments, the determining the one or more hierarchical levels (Step 282) further comprises determining that the one or more hierarchical levels associated with the one or more ML models correspond to a specific network function. The generating the one or more IDs of the one or more ML models (Step 284) further includes structuring a ML model ID to have a plurality of sub-IDs, the plurality of sub-IDs including a plurality of fields corresponding to a network function sub-ID, a ML model structure sub-ID, a ML model delivery format sub-ID, a version sub-ID, a device or vendor sub-ID, an additional sub-ID, or a combination thereof. The generating the one or more IDs of the one or more ML models (Step 284) further comprises structuring a ML model ID as a network function ID to have a plurality of functionality sub-IDs associated with the specific network function, the plurality of functionality sub-IDs containing a plurality of fields indicative of a number of network functions and one or more network functions.

In various embodiments, the method 280 further includes receiving a first identification (ID) of a first ML model from a user equipment or a base station communication with the user equipment in the wireless communication networks, and based on the received first ID, determining that the first ML model corresponds to an untrained model or a trained model and that the ML model delivery format corresponds to an open source delivery format or a proprietary delivery format.

The method 280 further includes determining that the one or more ML models are one-sided and residing at the user equipment or the base station or two-sided and residing at both the user equipment and the base station. The method 280 further includes determining a collaboration level relating to the one or more ML models between a user equipment and a base station communicating with the user equipment in the wireless communication networks. In case of no collaboration, no model ID or any part of model ID will not be signaled. In case of a limited collaboration with ML model awareness, a model ID or a part of model ID can be signaled between the network and the UE. In case of a model transfer, a full model ID or a part of model ID may be needed to be signaled between the network and the UE. The method 280 further includes receiving a second identification (ID) of a second ML model from the user equipment or the base station communication with the user equipment, and based on the received second ID and the determined collaboration level, determining that the second ML model is delivered in a form of a full ML model or in a form of ML model weight and parameters.

FIG. 2J depicts an illustrative embodiment of a method in accordance with various aspects described herein. The method 285 includes determining a hierarchical level of a machine learning (ML) model deployed in wireless communication networks including a radio access network (RAN) (Step 286), and based on the determined hierarchical level, generating an identification (ID) of the ML model, wherein the ID of the ML model indicates one or more network functions associated with the ID of the ML model, a ML model structure, a ML model delivery format, or a combination thereof. (Step 288). The ID of the ML model is globally unique within the wireless communication networks. In various embodiments, the determining the hierarchical level (Step 286) further includes determining that the hierarchical level associated with the ML model corresponds to a specific network function, and the generating the ID of the ML model further comprises structuring the ID of the ML model as a network function ID associated with the specific network function. The network function ID includes a plurality of functionality sub-IDs and the plurality of functionality sub-IDs contain a plurality of fields, each field indicative of each of one or more network functions and a total number of the one or more network functions. The generating the ID of the ML model (Step 288) further includes structuring the ID of the ML model to have a plurality of sub-IDs, the plurality of sub-IDs including a plurality of fields corresponding to a network function sub-ID, a ML model structure sub-ID, a ML model delivery format sub-ID, a version sub-ID, a device or vendor sub-ID, an additional sub-ID, or a combination thereof.

In various embodiments, the method 285 further includes identifying, based on the generated ID of the ML model, the ML model structure and that the ML model corresponds to an untrained model or a trained model, and identifying, based on the generated ID of the ML model, the ML model delivery format and that the ML model delivery format corresponds to an open source delivery format or a proprietary delivery format. The method 285 further includes determining a collaboration level of the ML model between a base station and a user equipment in the RAN, determining that the ML model resides at one of the base station and the user equipment or at both the base station and the user equipment, and, based on the identified model structure, the identified model delivery format, the determined collaboration level and the determined residing of the ML model, determining a transfer detail of the ML model.

In various embodiments, each of the one or more IDs comprise a plurality of sub-IDs contained in a plurality of data fields (Step 290 in FIG. 2J). The plurality of sub-IDs includes information indicative of an open-source ML model structure or a proprietary ML model structure and the plurality of data fields include a reserved field (Step 290 in FIG. 2J). The method further includes determining a collaboration level relating to the one or more ML models between a network element and a user equipment, and based on the one or more IDs of the one or more ML models and the determined collaboration level, identifying life cycle management corresponding to the one or more ML models (Step 292 in FIG. 2J). In some embodiments, the identifying the life cycle management further comprises performing an activation, a deactivation or a fallback of the one or more ML model. In other embodiments, the identifying the life cycle management further comprises performing a model delivery or a model update of the one or more ML model. The method further includes transmitting at least a part of the plurality of sub-IDs to a user equipment or a base station, and compressing one or more unused sub-IDs among the plurality of sub-IDs to reduce a signaling overhead (Step 294 in FIG. 2J).

While for purposes of simplicity of explanation, the respective processes are shown and described as a series of blocks in FIGS. 21 and 2J, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The above described embodiments provide a flexible and expandable classification for different types of ML models based on different use cases. The hierarchical model ID can not only be used for all current use cases but also be compatible with future models. The hierarchical model ID is efficient as a required part of model ID may be transmitted for the LCM. The above described embodiments are applicable to accommodate different collaboration levels between the network and the UE. The network can monitor the performance of the ML models operating at the UE with varying degrees of details and time granularities The above described embodiments facilitate easier testing and calibration of ML models.

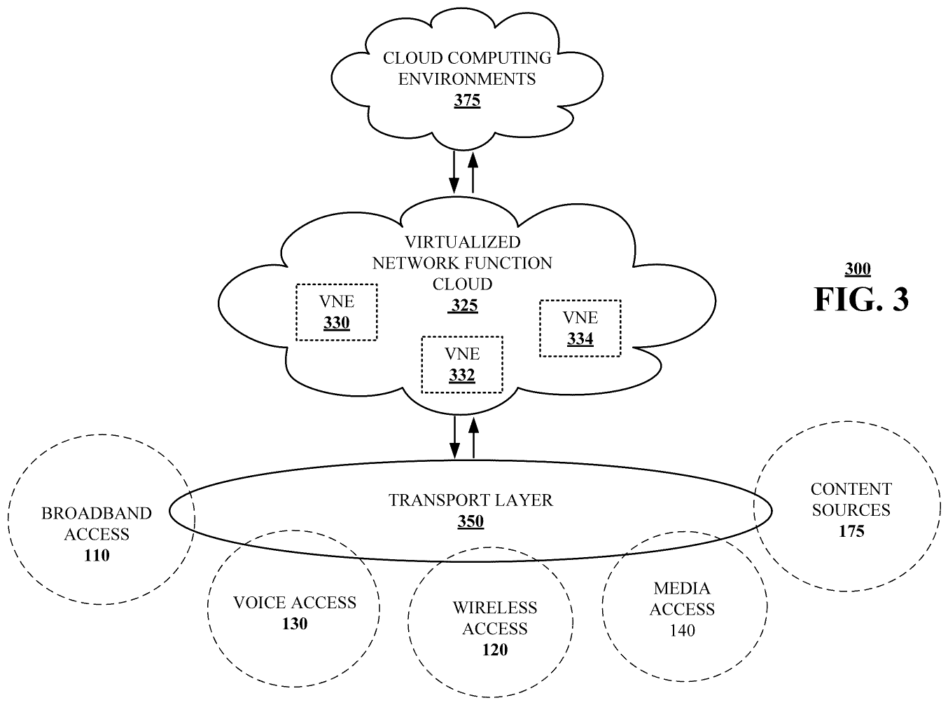

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part generating an identification (ID) of a machine learning (ML) model deployed in wireless communication networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

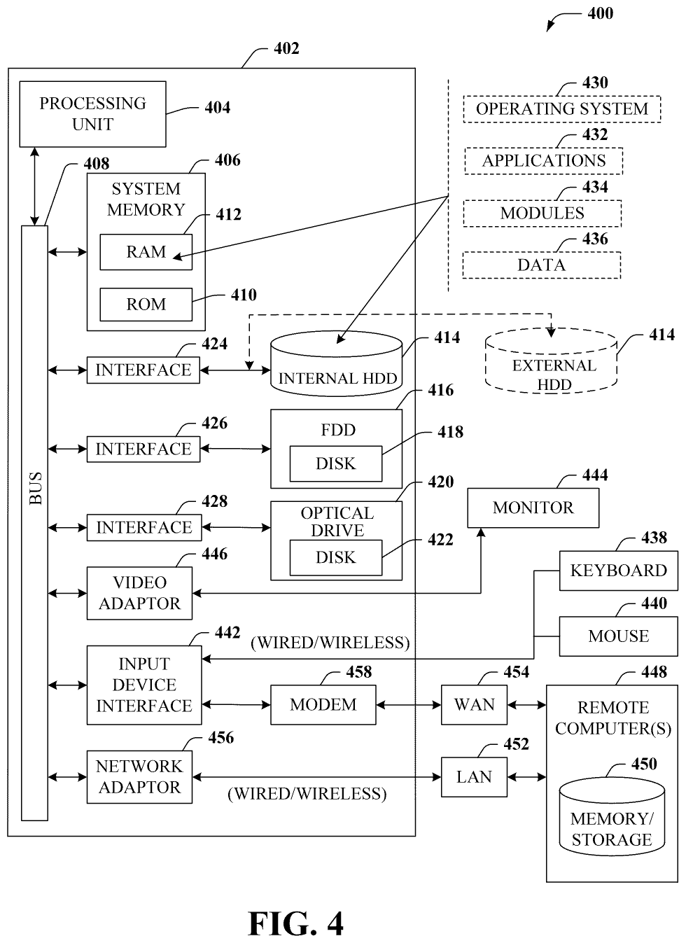

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part generating an identification (ID) of a machine learning (ML) model deployed in wireless communication networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

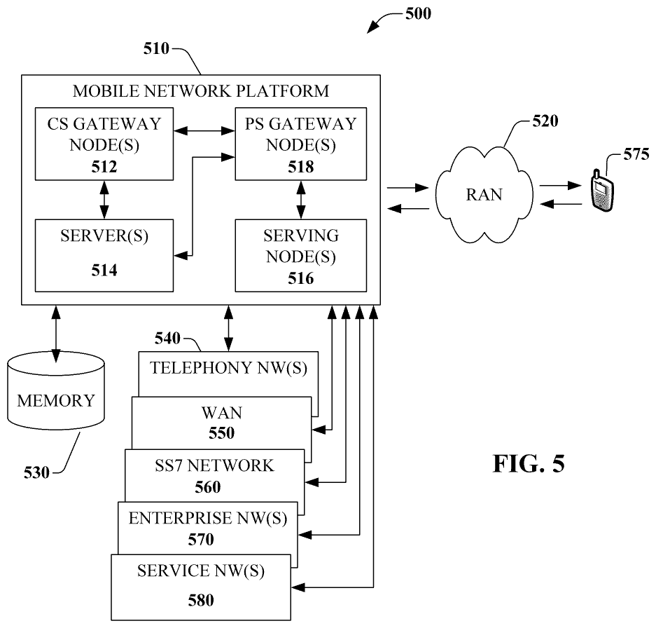

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part generating an identification (ID) of a machine learning (ML) model deployed in wireless communication networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

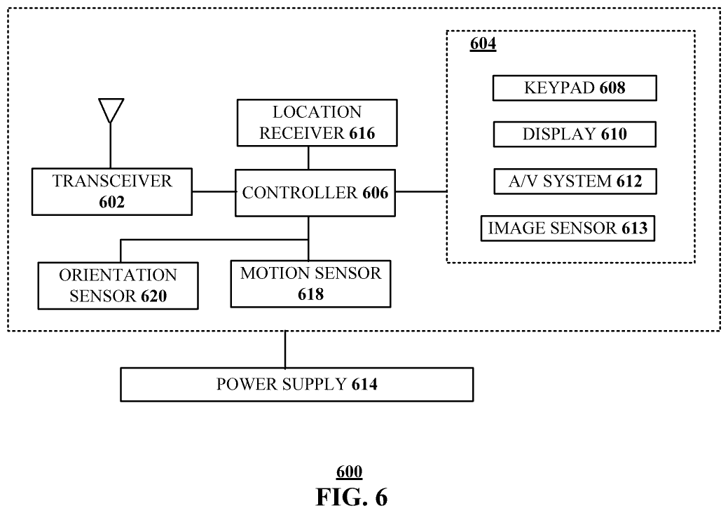

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part generating an identification (ID) of a machine learning (ML) model deployed in wireless communication networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(X₁, X₂, X₃, X₄ . . . . Xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

One or more of the embodiments described herein can be combined in whole or in part with the embodiments described in co-pending U.S. patent application Ser. No. ______ (having Attorney Docket No. 2023-0226_7785-3347A), entitled “PROTOCOL AND SIGNALING FRAMEWORK ENABLING MACHINE LEARNING MODELS IN WIRELESS COMMUNICATION NETWORKS,” filed on even date herewith, the disclosure of which is hereby incorporated by reference herein.

One or more of the embodiments described herein can be combined in whole or in part with the embodiments described in co-pending U.S. patent application Ser. No. ______ (having Attorney Docket No. 2023-0145_7785-3349A), entitled “METHODS, SYSTEMS, AND DEVICES IN SELECTING ARTIFICIAL (AI)/MACHINE LEARNING (ML) MODELS IN RADIO ACCESS NETWORKS,” filed on even date herewith, the disclosure of which is hereby incorporated by reference herein.

What is claimed is:

1. A method, comprising:
determining, by a processing system including a processor, one or more hierarchical levels associated with one or more machine learning (ML) models deployed in wireless communication networks; and
generating one or more identifications (IDs) of the one or more ML models based on the one or more hierarchical levels, wherein the one or more IDs of the one or more ML models indicate one or more network functions associated with the one or more IDs, a ML model structure, a ML model delivery format, or a combination thereof.

2. The method of claim 1, wherein the generating the one or more IDs of the one or more ML models further comprises structuring a ML model ID to have a plurality of sub-IDs, the plurality of sub-IDs including a plurality of fields corresponding to a network function sub-ID, a ML model structure sub-ID, a ML model delivery format sub-ID, a version sub-ID, a device or vendor sub-ID, an additional sub-ID, or a combination thereof.

3. The method of claim 1, wherein:
the determining the one or more hierarchical levels further comprises determining that the one or more hierarchical levels associated with the one or more ML models correspond to a specific network function; and
the generating the one or more IDs of the one or more ML models further comprises structuring a ML model ID as a network function ID to have a plurality of functionality sub-IDs associated with the specific network function, the plurality of functionality sub-IDs containing a plurality of fields indicative of a number of network functions and one or more network functions.

4. The method of claim 1, further comprising:
receiving, by the processing system, a first identification (ID) of a first ML model from a user equipment or a base station communicating with the user equipment in the wireless communication networks; and
based on the received first ID, determining that the first ML model corresponds to an untrained model or a trained model and that the ML model delivery format corresponds to an open source delivery format or a proprietary delivery format.

5. The method of claim 1, further comprising:
determining, by the processing system, that the one or more ML models are one-sided and residing at a user equipment or a base station or two-sided and residing at both the user equipment and the base station.

6. The method of claim 1, further comprising:
determining, by the processing system, a collaboration level relating to the one or more ML models between a user equipment and a base station communicating with the user equipment in the wireless communication networks.

7. The method of claim 6, further comprising:
receiving, by the processing system, a second identification (ID) of a second ML model from a user equipment or a base station communication with the user equipment; and
based on the received second ID and the determined collaboration level, determining that the second ML model is delivered in a form of a full ML model or in a form of ML model weight and parameters.

8. The method of claim 6, further comprising:
upon the determination of a collaboration level supporting predetermined life cycle management procedures, facilitating, by the processing system, a data collection, a model transfer, functionality activation, deactivation, switching or monitoring, or a combination thereof.

9. A non-transitory machine-readable medium, comprising executable instructions that, when executed by a processing system including a processor, facilitate performance of operations, the operations comprising:
determining a hierarchical level of a machine learning (ML) model deployed in wireless communication networks including a radio access network (RAN); and
based on the determined hierarchical level, generating an identification (ID) of the ML model, wherein the ID of the ML model indicates one or more network functions associated with the ID of the ML model, a ML model structure, a ML model delivery format, or a combination thereof; and
wherein the ID of the ML model is globally unique within the wireless communication networks.

10. The non-transitory machine-readable medium of claim 9, wherein the operations further comprise:
identifying, based on the generated ID of the ML model, the ML model structure and that the ML model corresponds to an untrained model or a trained model; and
identifying, based on the generated ID of the ML model, the ML model delivery format and that the ML model delivery format corresponds to an open source delivery format or a proprietary delivery format.

11. The non-transitory machine-readable medium of claim 9, wherein the generating the ID of the ML model further comprises structuring the ID of the ML model to have a plurality of sub-IDs, the plurality of sub-IDs including a plurality of fields corresponding to a network function sub-ID, a ML model structure sub-ID, a ML model delivery format sub-ID, a version sub-ID, a device or vendor sub-ID, an additional sub-ID, or a combination thereof.

12. The non-transitory machine-readable medium of claim 9, wherein:
the determining the hierarchical level further comprises determining that the hierarchical level associated with the ML model corresponds to a specific network function; and
the generating the ID of the ML model further comprises structuring the ID of the ML model as a network function ID associated with the specific network function, wherein the network function ID includes a plurality of functionality sub-IDs and the plurality of functionality sub-IDs contain a plurality of fields, each field indicative of each of one or more network functions and a total number of the one or more network functions.

13. The non-transitory machine-readable medium of claim 10, wherein the operations further comprise:
determining a collaboration level of the ML model between a base station and a user equipment in the RAN;
determining that the ML model resides at one of the base station and the user equipment or at both the base station and the user equipment; and
based on the identified model structure, the identified model delivery format, the determined collaboration level and the determined residing of the ML model, determining a transfer detail of the ML model.

14. A device, comprising:
a processing system including a processor; and
a memory that stores executable instructions that, when executed by the processing system, facilitate performance of operations, the operations comprising:
determining one or more hierarchical levels associated with one or more machine learning (ML) models deployed in wireless communication networks; and
based on the one or more hierarchical levels, generating one or more identifications (IDs) of the one or more ML models, wherein each of the one or more IDs comprise a plurality of sub-IDs contained in a plurality of data fields.

15. The device of claim 14, wherein the plurality of sub-IDs includes a network function ID, an ML model structure ID, an ML model format ID, an ML model version ID, a device or vendor ID, or a combination thereof.

16. The device of claim 14, wherein the plurality of sub-IDs includes information indicative of an open-source ML model structure or a proprietary ML model structure and the plurality of data fields include a reserved field.

17. The device of claim 14, wherein the operations further comprise:
determining a collaboration level relating to the one or more ML models between a network element and a user equipment; and
based on the one or more IDs of the one or more ML models and the determined collaboration level, identifying life cycle management corresponding to the one or more ML models.

18. The device of claim 17, wherein the identifying the life cycle management further comprises performing an activation, a deactivation or a fallback of the one or more ML model.

19. The device of claim 17, wherein the identifying the life cycle management further comprises performing a model delivery or a model update of the one or more ML model.

20. The device of claim 15, wherein the operations further comprise:
transmitting at least a part of the plurality of sub-IDs to a user equipment or a base station; and
compressing one or more unused sub-IDs among the plurality of sub-IDs to reduce a signaling overhead.
